(19) United States
(12) Patent Application Publication
(10) Pub. No.: US 2014/0278685 A1
(43) Pub. Date: Sep. 18, 2014

(54) Computer-Implemented Search System With Blog

(71) Applicant: Kuyam Companies, Inc., Los Angeles, CA (US)

(72) Inventor: Kourosh Gohar, Los Angeles, CA (US)

(73) Assignee: Kuyam Companies, Inc., Los Angeles, CA (US)

(21) Appl. No.: 14/273,314

(22) Filed: May 8, 2014

Related U.S. Application Data
(63) Continuation-in-part of application No. 14/043,726, filed on Oct. 1, 2013.
Application No. 14/043,726 is a continuation-in-part of application No. 13/941,397, filed on Jul. 12, 2013.
Application No. 13/941,397 is a continuation-in-part of application No. 13/872,023, filed on Apr. 26, 2013.
Application No. 13/872,023 is a continuation-in-part of application No. 13/837,413, filed on Mar. 15, 2013.

(51) Int. Cl. G06Q 10/10

(52) U.S. Cl. CPC G06Q 10/1095
USPC 705/7.19

(57) ABSTRACT

A computer implemented method of booking an appointment desired by a user comprising compiling a database of service companies available for the user to search, the database comprising a profile about each company, the profile comprising one or more of, the company's category of services provided, the location of the company and the available appointment days and times for providing the services. A platform operable by a platform operating company having a computer processor accessable by a user operating a computer or mobile device having a mobile application operable on the mobile device.

This application is a continuation-in-part application of U.S. patent application Ser. No. 13/941,397 filed Jul. 12, 1013; which is a continuation-in-part of U.S. patent application Ser. No. 13/872,023 filed Apr. 26, 2013, which is a continuation-in-part application of U.S. patent application Ser. No. 13/837,413 filed Mar. 15, 2013, which is a continuation-in-part application of U.S. patent application Ser. No. 14/043,726 filed Oct. 1, 2013 all of which applications are incorporated herein by reference, in their entireties.

### FIELD OF THE INVENTION

The invention described herein comprises an informational and educational blog within a platform that acts as a marketplace which empowers its users, the buyers of listed services and its establishments, the sellers of listed services, the capabilities to search, discover, schedule, share and store a user based schedule and blogs.

### BACKGROUND OF THE INVENTION

Technology has provided public and private establishments with many means for consumers to schedule appointments. Consumers can make an appointment with an establishment over the phone or via email. Some establishments even offer consumers an option to schedule appointments online by visiting the establishment's website. While technology has made this process easier, consumers who wish to make appointments with multiple establishments have to make several phone calls, and/or log onto several different websites for each establishment. Furthermore, most establishments still lack the means to allow consumers to make appointments online. These limitations waste valuable time and are mistake prone. There is a need to provide consumers with a single integrated platform, a “one stop shop”, which allows consumers to make, modify or cancel online appointments, all on one platform.

There is also a need for a more effective search system that makes it easier for a user to find and learn about companies and businesses and book appointments with them.

The system of this invention, as described in the parent applications, provides means to easily and effectively search using the platform web site or using a mobile phone or smartphone, to find a company for which the user has a need. This can be accomplished using the system search features to search for a specific category, favorite company and/or previously purchased packages. The search can also be made by selecting category icons that represent the services that the companies offer through the platform.

### SUMMARY OF THE INVENTION

A Kuyam agent, with the platform operating company, is able to send push notifications to users who have the mobile app installed, to notify them about proposed appointments or any other text message, so that they can get in touch with a customer about personalized communications easily.

Push notifications can be delivered to any user who has the kuyam app installed on at least one device. Kuyam agents can send general message push notification containing message text, and when the user taps on notification, it opens the app and takes them directly to the chat screen, initiating a chat session between the user and the agents. The text in the push notification message is displayed in the chat session, and visible to both the user and the agent. The agent can type a message “send push message” and the user can type in their message and click “send”.

A kuyam blog author can insert a company profile and availability buttons into their blog post, so that when a specific company is referenced in the blog article, the author can enable users to click a button to go straight to that company's profile page to book an appointment at a specific time. Blog authors can insert as many company availability profiles and availability buttons into their post as they wish.

A third-party blogger can also insert a company script or profile on their blog subject to approval by Kuyam. A blog author can insert as many companies into their post as they want for different companies and the blog author can insert companies into any position of the blog content. Three or more black time-slot buttons can be displayed for each company profile for both web and mobile use. Tapping a time-slot button takes the user directly into the booking process. When the user clicks on a black time-slot button, they are taken into the company profile page and Kuyam platform booking process with that specific start time selected for the correct day that the user selected.

A new feature is the introduction of a General Availability Button. A user will advise a range of time periods in which they are available. Then Kuyam representatives will call to find a company to see if they have a similar time period available. If a company has the time available the Kuyam agent will call the user back to confirm and then go through the process of booking the appointment. This feature is available on mobile device and web site.

An additional new feature in the system is for a third party company (not on kuyam's platform) to have a button or widget on the third party's website. The company creates its own button or Kuyam gives a button or widget to the company. A user is able to use the button or widget. The user is taken to a kuyam interface to see the third party company's availability. The user can then book an appointment.

The Kuyam company administrators will generate a booking script/link for each kuyam company. There are two scripts, one for a button and one for text. When a user clicks on the link from the 3^{rd} party company website, a display availability screen shows first, then asking for login or signup if the user wants to book it. If the user has been logged in, it is not necessary to log in again.

Instead of showing an empty calendar with white spaces which indicate availability, there can be shown black time-slot buttons, or other colors, which indicate available start times. The color buttons only appear where there is availability for the currently selected date and time.

If a company has been tagged by a kuyam administrator to show a category first, before choosing a service, then the user is directed to select a category. After they have selected a category, then there will be a menu or other list of services available from that company, so that the user can choose the service they desire. This applies to the web and mobile use.

A live or digital event, such as “Beautify LA” can be run, in which consumers will be able to book appointments with a select lists of companies at regular or reduced prices. A landing page will be created that promotes booking appointments for the event. Users can sign up with their email address, to receive emails about the event and there will be links to some of the participating companies. A “mobile-friendly” version of a landing page that is displayed, will be made for user's with mobile devices.

A new addition to the system is that a hotel concierge or staff person can generate hotel codes for guests, so that a guest can install an app and use it to view companies. Optionally, a hotel concierge can use the kuyam system to book appointments for hotel guests, so that the concierge will not have to make so many phone calls to companies to schedule appointments. The basic workflow is to enable a hotel concierge to log into a concierge dashboard for their hotel, and from there, add guest visits and book appointments for guests. In this case the guests themselves, do not have to sign up for the kuyam system. A kuyam administrator may create a new user account for the concierge.

Guest visits may have the following information: name, room, email, phone, check-in date, check-out date, and action taken. The concierge can manage appointment by clicking on the “appointments” link in their dashboard, to view a full list of appointments that were booked by a concierge associated with the concierge user's hotel. The concierge can only see appointments booked for their hotel guests between the time of the guest visit check-in and check-out.

If a concierge enters a guest into kuyam who has not previously signed up for kuyam, and the concierge books appointments on the guest's behalf, the guest will not receive any communications from kuyam. The only communications that may occur are between the concierge and the kuyam agent. The concierge will receive an email or call for appointment confirmed, appointment changed, appointment canceled, appointment update. If the guest later signs up for kuyam, this customer may receive all the communications available for a signed-in person.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method of booking an appointment desired by a user comprising:
compiling a database of service companies available for the user to search;
the database comprising a profile about each company;
the profile comprising one or more of, the company's category of services provided, the location of the company and the available appointment days and times for providing the services;
providing a platform operable by a computer processor accessable by a user operating a mobile device;
a mobile application operable on a mobile device;
push notifications sent to users who have the mobile application installed, to notify them about information.

2. The method of booking an appointment of claim 1 in which the information is about proposed appointments.

3. The method of booking an appointment of claim 1 in which the push notification takes the user directly to a chat screen.

4. The method of booking an appointment of claim 1 in which a blog author who writes about a service company is provided with a button, connected to the service company, allowing blog readers to click the button taking them directly to the service company.

5. The method of booking an appointment of claim 5 in which the blogger has a plurality of buttons for a plurality of service companies, discussed in the blogger's blog.

6. The method of booking an appointment of claim 1 in which the computer or mobile device has a general availability button which is used to determine the time period that the user is available for services.

7. The method of booking an appointment of claim 6 in which a kuyam agent checks with the service provider and the user's requested availability time periods to see if they match.

8. The method of booking an appointment of claim 1 in which a third party company is provided with a button or widget on their web site which direct users to an interface to schedule appointments.

9. A computer implemented method of booking an appointment desired by a user comprising:
compiling a database of service companies available for the user to search;
the database comprising a profile about each company;
the profile comprising one or more of, the company's category of services provided, the location of the company and the available appointment days and times for providing the services;
providing a platform operable by a platform operating company having a computer processor accessable by a user operating a computer or a mobile device;
in which the platform operating company provides a booking script for each service company that is associated with the platform operating company.

10. The method of booking an appointment of claim 9 in which a company has been tagged to show a category first and the user is notified to select a category, the user selects a category where a menu appears showing services provided by the company.

11. The method of booking an appointment of claim 9 in which a hotel concierge can issue codes to hotel guests to download an app which allows hotel guests to arrange appointments.

12. The method of booking an appointment of claim 9 in which a hotel concierge can issue codes to hotel guests which directs guests to a booking platform.

13. The method of booking an appointment of claim 9 in which the concierge utilizes a concierge dashboard for making appointments for guests.

14. The method of booking an appointment of claim 9 in which the concierge uses the platform operating company to arrange the appointments.
